(19) United States
(12) Patent Application Publication
(10) Pub. No.: US 2007/0012364 A1
(43) Pub. Date: Jan. 18, 2007

(54) Valve assembly

(76) Inventor: Ali Marandi, Irvine, CA (US)

Correspondence Address: Boniard I. Brown, Suite 200, 1710 West Cameron Avenue, West Covina, CA, 91790, US

(21) Appl. No.: 11/184,667

(22) Filed: Jul. 18, 2005

(51) Int. Cl. F16L 5/00

(52) U.S. Cl. 137/364

(57) ABSTRACT

A valve assembly has a gland disposed about a conduit to a water source, a flange floor extending transversely about the conduit, a tubular sleeve extending upwardly from the flange floor, a valve gland below the flange floor sealingly engaging a lower valve body, and at least one member extending upwardly from the periphery of the flange floor to retain the sleeve positioned on said flange floor.

### BACKGROUND AND SUMMARY OF THE INVENTION

The present invention relates to a valve assembly having a gland disposed about a conduit, a flange floor extending about the conduit, a sleeve extending upwardly from the flange floor, a valve gland extending below the flange floor, and at least one member extending upwardly from the flange floor to retain the sleeve positioned thereon.

Means on the conduit enable control of flow therethrough.

Means are provided to retain the sleeve on the flange floor, typically comprising a flange extending upwardly from the flange floor or a plurality of lugs extending upwardly from an outer rim of the flange floor. The flange floor has a central opening to receive the conduit.

An annular seal disposed in a groove in the valve gland engages a valve body. Preferably, a shroud member is provided to prevent foreign matter from entering the valve assembly.

The flange floor has a central opening in the flange floor to receive the conduit and a tubular portion extends downwardly about said conduit. A sleeve extends upwardly from the flange floor, and a circular shroud member extends upwardly from the flange floor and about the sleeve.

A shroud member may be provided to prevent foreign matter from entering the valve assembly.

### BRIEF DESCRIPTION OF THE DRAWINGS

FIG. 1 is a sectional view of a preferred embodiment of the present invention;

FIG. 2 is a sectional view of an embodiment of the invention similar to that of FIG. 1 except for the addition of a downwardly extending portion depending from a flange floor;

FIG. 3 is a sectional view of an embodiment of the invention similar to that of FIG. 2, except for a plurality of lugs spaced about a flange member to maintain a sleeve member in position;

FIG. 4 is a sectional view taken at line 4-4 in FIG. 1; and

FIG. 5 is a sectional view taken at line 5-5 in FIG. 3.

### DESCRIPTION OF PREFERRED EMBODIMENTS

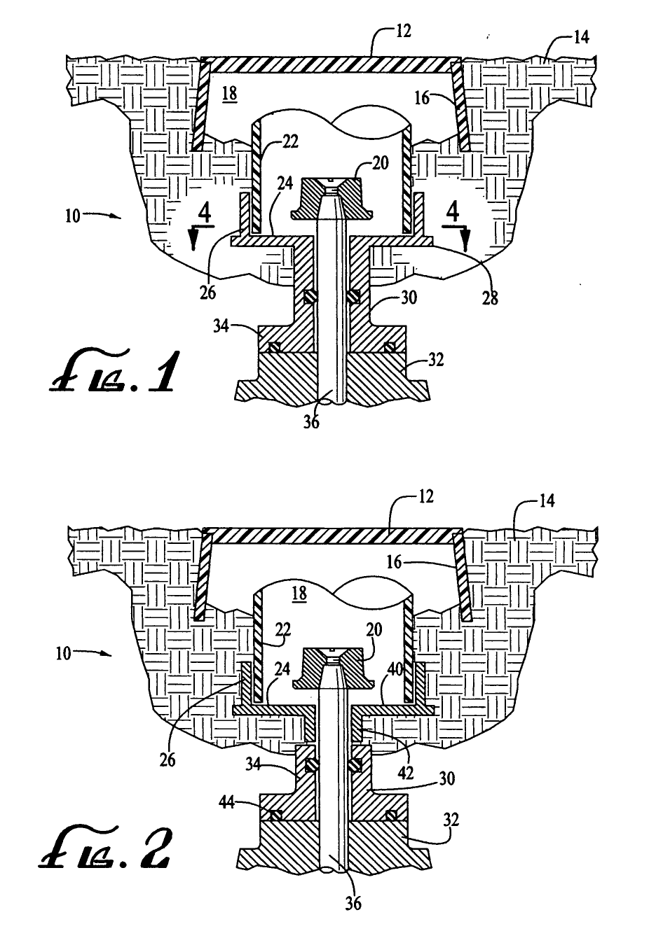

Referring to the drawings, and particularly to FIG. 1, a preferred embodiment 10 of the invention is shown as comprising a shroud 12 having a generally horizontal portion flush with a ground surface 14, and having a generally cylindrical skirt portion 16 extending downwardly into the ground to prevent entry of debris into a space 18. Debris in this space could make operation of a valve handle 20 difficult or even impossible.

A sleeve 22 extends downwardly from the space defined by the shroud 12 and is supported on a bottom flange floor 24 from which extends upwardly a circular shroud 26. An annular extension of flange 24 extends outwardly beyond the shroud 26, as shown.

A valve gland 30 extends downwardly from flange 24 and a lower portion thereof extends outwardly to engage a valve body 32 with an annular resilient seal therebetween.

A vertical conduit 36 is connected with a source of water (not shown) and has mounted on its upper end the valve handle 20 for manual rotation to control passage of water therethrough.

FIG. 2 shows an embodiment of the invention wherein a modified flange 40, similar to flange 24 of FIG. 1, and having a downwardly extending annular portion 42 disposed about the conduit 36, which engages an annular seal disposed in valve gland 34 and is sealingly engaged with valve body 32 by annular seal 44.

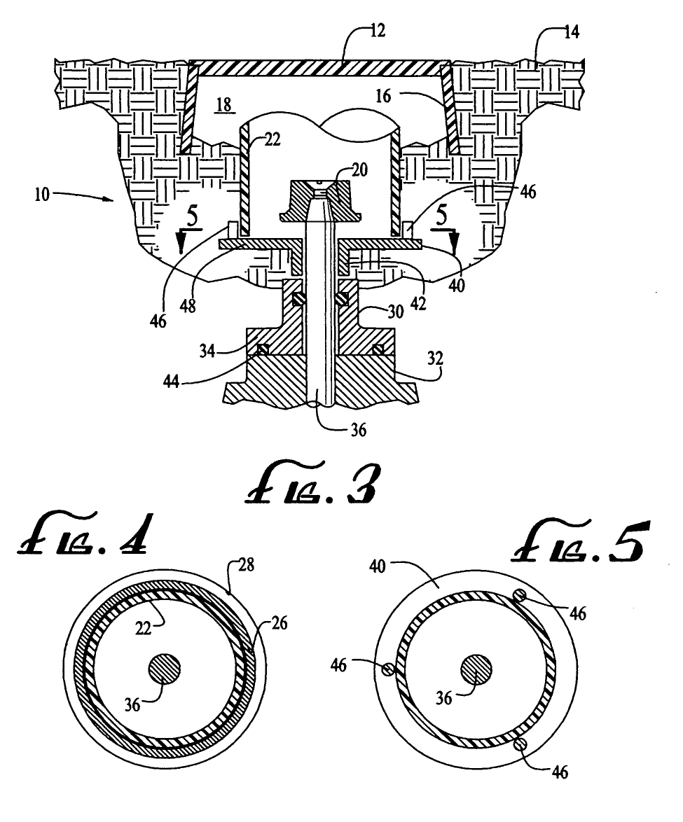

Shown in FIG. 3 is an embodiment which is generally similar to that of FIG. 2, but which has three or more lugs 46 which are spaced apart about the periphery of a flange floor 48 and extend upwardly from the flange floor to center the positioning of the PVC sleeve 22 on the flange floor.

The valve assembly has a shroud 12 having an upper generally horizontal portion at about ground level, and a downwardly extending skirt portion 16 extending about and spaced from the sleeve 22 which extends upwardly from the flange floor 48. Resilient annular seal means 44 is disposed in a groove in the valve gland and engages the valve body.

In the embodiment of FIG. 1, the flange floor 24 is integral with the valve gland, which has a radial outwardly extending flange portion wherein a resilient seal 44 is disposed in a groove in a lower portion of the valve gland and engages the valve body 32.

In the embodiment of FIG. 3, a flange floor 48 extends transversely about the conduit, and has a central opening to receive the conduit 36, and the flange floor 48 has a downwardly extending tubular portion disposed about the conduit. A plurality of lugs 46 are spaced apart about and extend from a peripheral portion of the flange to retain the tubular sleeve on the flange. A sleeve extends upwardly from the flange floor.

A shroud 12 serves to prevent foreign matter from entering the valve assembly. The shroud has an upper generally horizontal portion at about ground level and a downwardly extending portion extending about sleeve 22 of the valve assembly.

The valve gland 30 has a radially extending flange portion, and a resilient seal is disposed between the gland portion and valve body 32.

It will be understood that various changes and modifications may be made from the preferred embodiments discussed above without departing from the scope of the present invention, which is established by the following claims and equivalents thereof.

The inventor claims:

1. A valve assembly comprising:
a valve gland having a flange floor on its upper portion,
a conduit extending through the valve gland for connection with a source of water,
means on the conduit operable to control flow through the conduit,
a tubular sleeve extending upwardly from said flange floor, and
means to retain said sleeve on the flange floor.

2. A valve assembly according to claim 1 and further comprising a shroud having an upper generally horizontal portion at about ground level and having a downwardly extending portion extending about said sleeve of the valve assembly.

3. A valve assembly according to claim 1 wherein said valve assembly comprises a gate valve.

4. A valve assembly according to claim 1 and further comprising a sleeve extending upwardly from the flange floor and circular shroud means extending upwardly from the flange floor and about the sleeve.

5. A valve assembly according to claim 1 and further comprising an annular resilient seal in a groove in the valve gland and engaging a valve body.

6. A valve assembly according to claim 1 wherein said flange floor is integral with said valve gland.

7. A valve assembly according to claim 1 wherein said valve gland has a radially extending flange portion and wherein a resilient seal is disposed between said gland portion and a valve body.

8. A valve assembly according to claim 1 wherein a resilient annular seal is disposed in a groove in a lower portion of said valve gland and engages a valve body.

9. A valve assembly according to claim 1 and further comprising shroud means to prevent foreign matter from entering the valve assembly.

10. A valve assembly comprising:
a valve gland disposed about a conduit connected with a source of water,
a flange floor extending about said conduit generally horizontally and transversely of said conduit,
said flange floor having a central opening to receive said conduit and a downwardly extending tubular portion disposed about said conduit, and
a valve gland below said annular portion and in sealing engagement with a lower valve body.

11. A valve assembly according to claim 10 and further comprising a shroud having an upper generally horizontal portion at about ground level and having a downwardly extending portion extending about said sleeve of the valve assembly.

12. A valve assembly according to claim 10 wherein said valve assembly acomprises a gate valve.

13. A valve assembly according to claim 10 and further comprising a sleeve extending upwardly from the flange floor and circular shroud means extending upwardly from the flange floor and about the sleeve.

14. A valve assembly according to claim 10 and further comprising an annular resilient seal in a groove in the valve gland and engaging a valve body.

15. A valve assembly according to claim 10 wherein said valve gland has a radially extending flange portion and wherein a resilient seal is disposed between said gland portion and a valve body.

16. A valve assembly according to claim 10 and further comprising shroud means to prevent foreign matter from entering the valve assembly.

17. A valve assembly comprising:
a valve gland disposed about a conduit connected with a source of water,
a flange floor extending about said conduit generally horizontally and transversely of said conduit,
a tubular sleeve seated on and extending upwardly from said flange floor,
a valve gland disposed below said flange and in sealing engagement with a lower valve body, and
a plurality of lugs spaced apart about and extending upwardly from a peripheral portion of said flange to retain said tubular sleeve on said flange.

18. A valve assembly according to claim 17 and further comprising a shroud having an upper generally horizontal portion at about ground level and having a downwardly extending portion extending about said sleeve of the valve assembly.

19. A valve assembly according to claim 17 and further comprising a sleeve extending upwardly from the flange floor and circular shroud means extending upwardly from the flange floor and about the sleeve.

20. A valve assembly according to claim 17 and further comprising an annular resilient seal in a groove in the valve gland and engaging a valve body.
